(19) United States
(12) Patent Application Publication
(10) Pub. No.: US 2019/0266429 A1
(43) Pub. Date: Aug. 29, 2019

(54) CONSTRAINED RANDOM DECISION FOREST FOR OBJECT DETECTION

(71) Applicant: QUALCOMM Incorporated, San Diego, CA (US)

(72) Inventors: Sujith Srinivasan, San Diego, CA (US); Rakesh Nattoji Rajaram, San Diego, CA (US); Gokce Dane, San Diego, CA (US); Vasudev Bhaskaran, San Diego, CA (US)

(21) Appl. No.: 15/903,981

(22) Filed: Feb. 23, 2018

(51) Int. Cl. G06K 9/32; G06K 9/62; G06K 9/46

(52) U.S. Cl. CPC G06K 9/3241; G06K 9/6282; G06K 9/4652; G06K 9/4642; G06K 9/4604

(57) ABSTRACT

A classifier for detecting objects in images can be configured to receive features of an image from a feature extractor. The classifier can determine a feature window based on the received features, and allows access by each decision tree of the classifier to only a predetermined area of the feature window. Each decision tree of the classifier can compare a corresponding predetermined area of the feature window with one or more thresholds. The classifier can determine an object in the image based on the comparisons. In some examples, the classifier can determine objects in a feature window based on received features, where the received features are based on color information for an image.

### CROSS-REFERENCE TO RELATED APPLICATIONS

None.

### STATEMENT ON FEDERALLY SPONSORED RESEARCH OR DEVELOPMENT

None.

### FIELD OF THE DISCLOSURE

This disclosure relates generally to image scanning systems and, more specifically, to object detection in image scanning systems.

### BACKGROUND

Image scanning systems, such as 3-dimensional (3D) image scanning systems, use sophisticated image capture and signal processing techniques to render video and still images. Object detection involves the identification of objects, such as faces, bicycles, or buildings, in images or videos rendered by image scanning systems (e.g., computer vision). For example, face detection may be used in digital cameras and security cameras. Object detection can be done in two steps: (1) feature extraction, and (2) classification of the extracted features. Feature extraction involves the identification of areas in an image that contain features, such as objects. Classification of extracted features involves identifying the type of feature extracted, such as identifying the type of object extracted.

### SUMMARY

In some examples, a scanning system includes a constrained random decision forest (CRDF) classifier with multiple constrained decision trees. The CRDF classifier can receive at least one feature of an image, and determine a feature window based on the received feature(s). Each constrained decision tree of the CRDF classifier can access a predetermined area of the feature window, and can compare the predetermined area of the feature window with one or more thresholds. For example, each constrained decision tree of the CRDF classifier can include multiple constrained nodes, where each constrained node compares a predetermined area of the feature window to a threshold. The CRDF classifier can detect an object in the image based on the comparisons.

In some examples, a classifier, such as an CRDF classifier or a CRDF classifier, receives feature data, such as feature descriptors, on one or more feature channels. The feature data corresponds to at least one image feature of an image. The one or more feature channels can be received from a feature extractor, such as a HOG feature extractor. The classifier can receive feature data based on color information. For example, the CRDF classifier can receive feature data from a feature extractor, where the feature data is based on image color information. For example, the feature extractor may provide features to the CRDF classifier based on image color information received on image channels, such as red, green, and/or blue (RGB) channels. As another example, the feature extractor may provide features to the CRDF classifier based on image color information received on luminance and chrominance (YUV) channels. The classifier can can detect an object in the image based on a feature window.

In some examples, a method for detecting objects in an image can include receiving, by a CRDF classifier with multiple constrained decision trees, at least one feature of an image. The method can include determining a feature window based on the received feature(s). The method can also include accessing, by each constrained decision tree of the CRDF classifier, a predetermined area of the feature window. The method can also include comparing, by each constrained decision tree of the CRDF classifier, the predetermined area of the feature window with one or more thresholds. The method can also include detecting an object in the image based on the comparisons.

In some examples, a method, by a classifier, for detecting an object in an image can include receiving feature data on one or more feature channels, where the feature data correspond to at least one image feature of an image. The method can include determining a feature window based on the received feature data. The method can include detecting at least one object in the image based on the determined feature window.

In some examples, a non-transitory, computer-readable storage medium includes executable instructions. The executable instructions, when executed by one or more processors, can cause the one or more processors to receive at least one feature of an image, and to determine a feature window based on the received feature(s). The executable instructions, when executed by the one or more processors, can cause the one or more processors to access a predetermined area of the feature window, and compare the predetermined area of the feature window with one or more thresholds. The executable instructions, when executed by the one or more processors, can cause the one or more processors to detect an object in the image based on the comparisons.

In some examples, a non-transitory, computer-readable storage medium includes executable instructions that when executed by one or more processors, can cause the one or more processors to receive feature data on one or more feature channels, where the feature data corresponds to at least one image feature of an image. The executable instructions, when executed by the one or more processors, can cause the one or more processors to determine a feature window based on the received feature data. The executable instructions, when executed by the one or more processors, can cause the one or more processors to detect at least one object in the image based on the determined feature window.

In some examples, a scanning system that includes a CRDF classifier with multiple constrained decision trees includes a means for receiving at least one feature of an image; a means for determining a feature window based on the received feature(s); a means for accessing, by each constrained decision tree of the CRDF classifier, a predetermined area of the feature window; a means for comparing, by each constrained decision tree of the CRDF classifier, the corresponding predetermined area of the feature window with one or more threshold; and a means for detecting an object in the image based on the comparisons.

In some examples, a classifier includes a means for receiving feature data corresponding to at least one feature of an image; a means for receiving image data for the image; a means for determining a feature window based on the received feature data and the received image data; and a means for detecting at least one object in the image based on the determined feature window.

### BRIEF DESCRIPTION OF DRAWINGS

FIG. 1 is a block diagram of an exemplary scanning system with a constrained random decision forest (CRDF) classifier;

FIG. 2 is a diagram of an exemplary constrained decision tree of the CRDF classifier of FIG. 1;

FIG. 3A is a diagram showing an example of a feature window that may be used by a prior art decision tree of a random decision forest classifier to evaluate a feature array;

FIG. 3B is a diagram showing an example of a predetermined area of a feature window that can be used by a constrained decision tree of the CRDF classifier of FIG. 1 to evaluate a feature array;

FIG. 4A is a diagram showing an example of a prior art feature window that may be used by a prior art decision tree of a random decision forest classifier to evaluate all columns of a feature array simultaneously;

FIG. 4B is a diagram showing an example of a predetermined area of a feature window that can be used by a constrained decision tree of the CRDF classifier of FIG. 1 to evaluate all columns of a feature array simultaneously;

FIG. 5 is a block diagram of another exemplary scanning system with a classifier;

FIG. 6 is a flowchart of an example method that can be carried out by a constrained decision tree of a CRDF classifier; and

FIG. 7 is a flowchart of another example method that can be carried out by an exemplary scanning system with a classifier.

### DETAILED DESCRIPTION

While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings. It should be understood, however, that the present disclosure is not intended to be limited to the particular forms disclosed. Rather, the present disclosure covers all modifications, equivalents, and alternatives that fall within the spirit and scope of these exemplary embodiments.

This disclosure provides a constrained random decision forest (CRDF) classifier that includes multiple constrained detection trees. The CRDF classifier receives feature data (e.g., feature descriptors, feature arrays) from a feature extractor. The feature data represents features of an image that are based on transformed image channels (e.g., luminance, chrominance, color, depth, etc.). Features can include, for example, average image pixel values, image gradients, or image edge maps. For example, the feature extractor can provide feature data corresponding to one or more image channels to the CRDF classifier. The features can also include implicit coordinate information, where the coordinate information indicates the coordinates of the feature in the image.

The CRDF classifier receives feature data from the feature extractor, and detects (e.g., classifies) objects based on the received feature data. For example, the CRDF classifier uses a feature window to classify objects located within the feature window. The feature window can represent areas of an image where features, such as objects, can be located in an image. For example, the feature window can have a size that is a subset of (e.g., smaller than) the image size. The CRDF classifier evaluates the feature data corresponding to the part of the image defined by the feature window based on threshold comparisons to generate a score, as described in more detail below. The CRDF classifier slides the feature window to different parts of the image, and evaluates feature data corresponding to each part of the image defined by the new positions of the feature window to generate scores. For example, the CRDF classifier can slide the feature window by one, two, four, or any number of pixels across a line of the image. When the end of the line is reached, the CRDF classifier can slide the feature window back to the first pixel, and down by one or more lines of the image. In this manner, the CRDF classifier evaluates feature data corresponding to all channels of the entire image. The CRDF classifier then classifies objects based on the determined scores.

Rather than allowing access to all locations of a feature window, the CRDF classifier includes constrained decision trees that are configured to access a predetermined area of the feature window. The predetermined area of the feature window can include locations within a subset of rows, a subset of columns, and/or a subset of channels of the feature window. As such, each constrained detection tree is “constrained” from accessing all locations of the feature window. The CRDF classifier then compares feature values associated with locations within the predetermined area of the feature window to one or more thresholds, as described in more detail below. Feature values are received in feature data and correspond to values of extracted features at a location (e.g., pixel location) of an image. The CRDF classifier uses the comparisons to classify objects within the feature window.

In some examples, a CRDF classifier includes one or more processors configured to receive at least one feature of an image. For example, the one or more processors can be configured to receive histogram of oriented gradients (HOG) values from a HOG extractor. The one or more processors are configured to determine a feature window based on the received feature(s). The one or more processors are configured to allow each constrained decision tree of a plurality of constrained decision trees of the CRDF classifier to access a predetermined area of the feature window. The one or more processors are configured to compare, for each constrained decision tree of the plurality of constrained decision trees, the corresponding predetermined area of the feature window with one or more thresholds. The one or more processors are configured to detect an object in the image based on the comparisons.

In some examples, the one or more processors are configured to determine (e.g., establish) the predetermined area of the feature window to include only a single row of a plurality of rows of the feature window. In some examples, the one or more processors are configured to determine the predetermined area of the feature window to include only a single column of a plurality of columns of the feature window.

In some examples, the feature window comprises a plurality of rows, a plurality of columns, and a plurality of channels, where the one or more processors are configured to determine the predetermined area of the feature window to comprise at least one of: only a single row of the plurality of rows, only a single column of the plurality of columns, or only a single channel of the plurality of channels. In some examples, the one or more processors are configured to determine the predetermined area of the feature window to comprise another of the at least one of: only a single row of the plurality of rows, only a single column of the plurality of columns, or only a single channel of the plurality of channels.

In some examples, the one or more processors are configured to determine the predetermined area of the feature window to comprise at least two of: only a single row of the feature window, only a single column of the feature window, or only a single channel of the feature window.

In some examples the one or more processors are configured to compare, for each node of a plurality of constrained nodes of each constrained decision tree, a different location of the predetermined area of the feature window with a corresponding threshold. In some examples the one or more processors are configured to differ the locations of the predetermined area of the feature window only by one or more rows, one or more columns, or one or more channels of the feature window.

In some examples, a CRDF classifier comprises one or more processors configured to receive feature data over feature channels based on image color information. For example, the CRDF classifier can receive feature data from a feature extractor that is based on red, green, or blue color channels. In these examples, the one or more processors are configured to determine a feature window based on the received feature data that is based on color information. The one or more processors are configured to detect at least one object in the image based on the determined feature window.

In some examples, the CRDF classifier resizes feature data received on feature channels to different resolutions. For example, if feature data corresponds to an image that is 1920 pixels by 1080 lines, the feature data can be resized (e.g., downsampled) to correspond to an image size (e.g., image resolution) of one or more of 1536 pixels by 864 lines, 1216 pixels by 688 lines, and 960 pixels by 544 lines. The feature data can be resized at a particular interval (e.g., by 25%).

In some examples, the CRDF classifier resizes the feature data until the resized feature data corresponds to an image that is the same size as the feature window size. As such, the CRDF classifier, employing a same feature window, can detect different sized objects. This allows, for example, the CRDF classifier to detect a smaller object when the feature data is not resized (e.g., the feature window corresponds to feature data corresponding to only a part of an image), but a larger object when the feature data is resized (e.g., the feature window corresponds to resized feature data corresponding to all of the same image). As such, the CRDF classifier can determine scores at all resolution levels to classify objects at the various resolution levels.

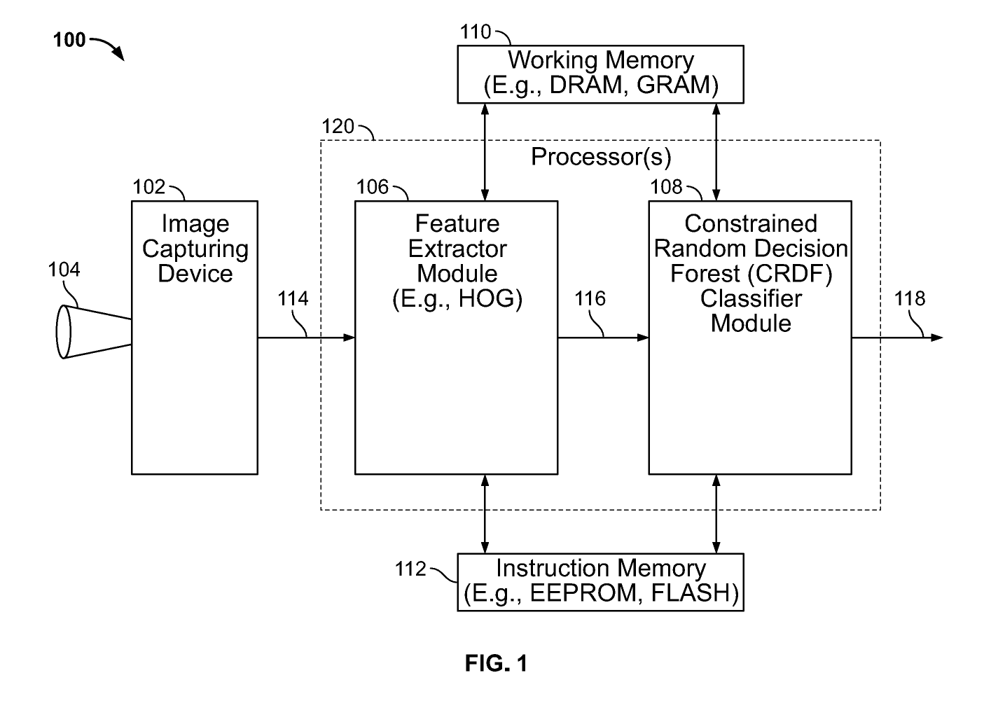

Turning to the figures, FIG. 1 is a block diagram of an exemplary scanning system 100 that includes a constrained random decision forest (CRDF) classifier module 108. The CRDF classifier module 108 includes multiple constrained decision trees each with a plurality of nodes. Scanning system 100 can be a stationary device such as a desktop computer, or it can be a mobile device, such as a cellular phone. Scanning system 100 includes an image capturing device 102 with camera(s) 104. Image capturing device 102 can be any suitable image capturing device that can capture images. For example, image capturing device can be a digital camera, a video camera, a smart phone, a stereo camera with right and left cameras, an infrared camera capable of capturing images, or any other suitable device. Image capturing device 102 is operable to capture images, such as three-dimensional (3D) images, and provides the captured images via image channels 114. Camera 104 can include dual cameras, such as a left camera and a right camera. The scanning system 100 also includes a feature extractor module 106. In some examples, feature extractor module 106 can be a Histogram of Oriented Gradients (HOG) feature extractor. Scanning system 100 can include more, or less, components than what are described.

Feature extractor module 106 is in communication with image capturing device 102 and can obtain (e.g., receive) captured images from image capturing device 102 via image channels 114. Feature extractor module 106 is also in communication with CRDF classifier module 108 and provides feature data (e.g., feature descriptors, feature arrays) via feature channels 116 to CRDF classifier module 108. The feature data identifies areas in images that can contain features, such as objects. CRDF classifier module 108 is operable to obtain the feature data from feature extractor module 106 and, based on classifying the feature data, can provide detected objects 118.

Each of feature extractor module 106 and CRDF classifier module 108 can be implemented with any suitable electronic circuitry. For example, feature extractor module 106 and/or CRDF classifier module 108 can include one or more processors 120 such as one or more microprocessors, image signal processors (ISPs), digital signal processors (DSPs), central processing units (CPUs), graphics processing units (GPUs), or any other suitable processors. Additionally, or alternatively, feature extractor module 106 and CRDF classifier module 108 can include one or more field-programmable gate arrays (FPGAs), one or more application-specific integrated circuits (ASICs), one or more state machines, digital circuitry, or any other suitable circuitry.

In this example each of feature extractor module 106 and CRDF classifier module 108 are in communication with instruction memory 112 and working memory 110. Instruction memory 112 can store executable instructions that can be accessed and executed by one or more of feature extractor module 106 and/or CRDF classifier module 108. For example, instruction memory 112 can store instructions that when executed by CRDF classifier module 108, cause CRDF classifier module 108 to perform one or more operations as described herein. In some examples, one or more of these operations can be implemented as algorithms executed by CRDF classifier module 108. The instruction memory 112 can include, for example, electrically erasable programmable read-only memory (EEPROM), flash memory, non-volatile memory, or any other suitable memory.

Working memory 110 can be used by feature extractor module 106 and/or CRDF classifier module 108 to store a working set of instructions loaded from instruction memory 112. Working memory 110 can also be used by feature extractor module 106 and/or CRDF classifier module 108 to store dynamic data created during their respective operations. In some examples, working memory 110 includes static random-access memory (SRAM), dynamic random-access memory (DRAM), or any other suitable memory.

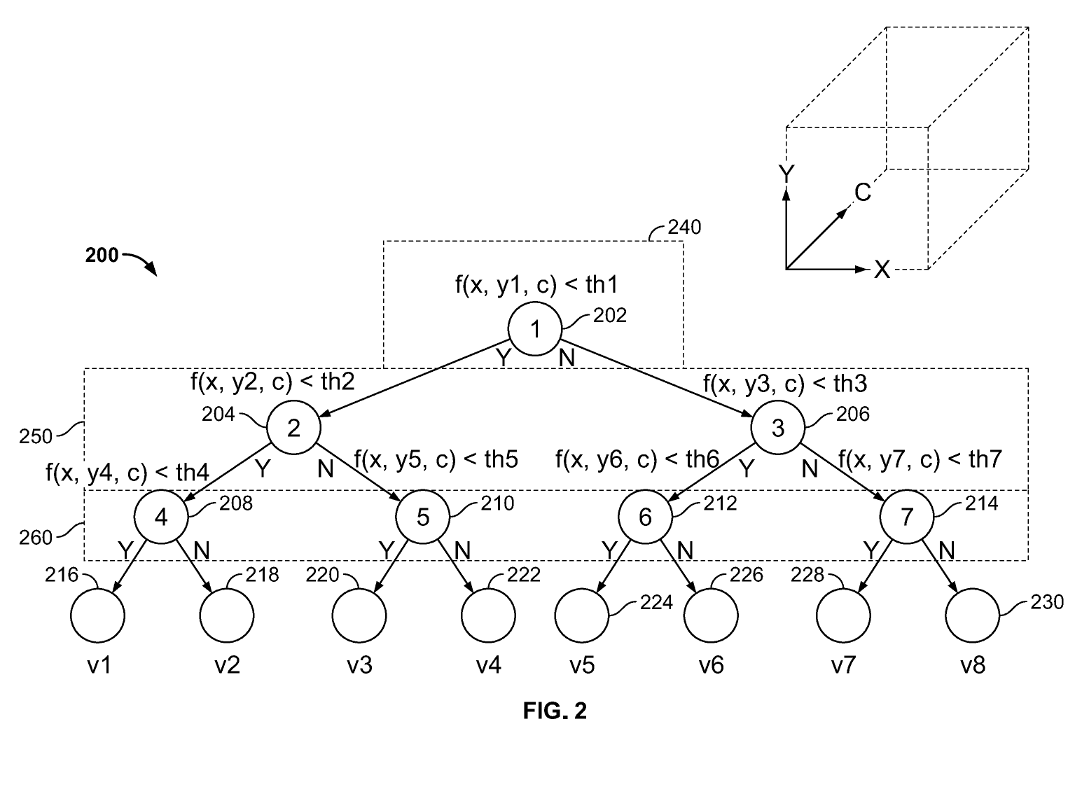

FIG. 2 illustrates a diagram of an exemplary constrained decision tree 200 of a CRDF classifier, such as the CRDF classifier module 108 of FIG. 1. Constrained decision tree 200 includes multiple levels 240, 250, 260 each with one or more constrained nodes. For example, a first level 240 of constrained decision tree 200 includes constrained node 202. A second level 250 of constrained decision tree 200 includes constrained nodes 204, 206. A third level 260 of constrained decision tree 200 includes constrained nodes 208, 210, 212, 214.

The constrained nodes can be constrained in one dimension, two dimensions, or three dimensions. In addition, the constrained nodes can be limited to evaluate one, two, or three dimensions of an image.

For example, a position within the feature window can be represented as a coordinate point. In this example, merely for convenience, a coordinate system of (x, y, c) is used, where “x” represents a row index, “y” represents a column index, and “c” represents a channel index. The “c” direction can represent the depth (e.g., channels) of a corresponding location of the feature window. Each of x, y, and c represent a distance from an origin of (0,0,0). For example, a feature window position of f(x, y, c) indicates a location of the feature window at row x, column y, and channel c.

At each constrained node, a feature value corresponding to a predetermined area (e.g., location) of a feature window (not shown) is compared to a threshold. Thresholds can be empirically determined, as described further below. The constrained nodes access feature data corresponding to only a predetermined area of a feature window. In other words, the constrained nodes within a constrained decision tree compare feature data associated only with the predetermined area of a feature window. In this example, the constrained nodes are constrained to access the same row (x) and channel (c) of the feature window, while the constrained nodes can access different columns of the feature window. For example, to perform the comparison at constrained node 202, a feature value at a location f(x, y1, c) of a feature window is accessed. To perform the comparison at constrained node 204, a location f(x, y2, c) of the feature window is accessed. To perform the comparisons for both of these nodes, the same row “x,” and the same channel “c,” of the feature window is accessed.

Similarly, in this example, all constrained nodes of constrained decision tree 200 can access only the same row “x” and channel “c” of the feature window. However, while any particular constrained decision tree 200 includes nodes similarly constrained, different constrained decisions trees of a CRDF classifier can be constrained differently, such that each constrained decision tree 200 is evaluating a different part of an image.

To perform the comparison at constrained node 202, column “y1” of the feature window is accessed, while column “y2” of the feature window is accessed to perform the comparison at constrained node 204. Similarly, in this example, all constrained nodes access a different column of the feature window, namely, columns y1 through y7. Thus, in this example, the constrained decision tree 200 can access a predetermined area of the feature window represented by row x, channel c, and columns y1 through y7 of the feature window.

In some examples, the constrained nodes access the same column of the feature window. Although in this example the constrained nodes are constrained to access the same row and channel of the feature window, in other examples the constrained nodes can be constrained to access any combination of one or more rows, one or more channels, and one or more columns of the feature window. For example, the constrained nodes of a constrained decision tree can be configured to access the same row, the same channel, and the same column of a feature window. As another example, the constrained nodes of a constrained decision tree can be configured to access only the same row and the same column of the feature window, but multiple channels of the feature window. As yet another example, the constrained nodes of a constrained decision tree can be configured to access only the same channel and the same column of the feature window, but multiple rows of the feature window.

At each constrained node, a feature value corresponding to a predetermined location of a feature window is compared to a threshold. For example, at node 202, a feature value at a location f(x, y1, c) of a feature window is compared to a threshold th1. In this example, if the value of the feature value at location f(x, y1, c) of the feature window is less than the threshold value of th1, then the decision tree proceeds to node 204. If the value of the feature value at location f(x, y1, c) of the feature window is not less than the threshold value of th1 (e.g., if the value of the feature value at location f(x, y1, c) of the feature window is equal to or greater than the threshold value of th1), then the decision tree proceeds to node 206.

At node 204, a feature value at a location f(x, y2, c) of the feature window is compared to a threshold th2. The location of the feature window that is accessed to perform this comparison includes the same row “x” and channel “c” of the feature window that was accessed to perform the comparison for node 202. Similarly, the location of the feature window that is accessed to perform all of the comparisons at all constrained nodes for constrained decision tree 200 include the same row “x” and channel “c.” If the value of the feature value at location f(x, y2, c) of the feature window is less than the threshold value of th2, then the decision tree proceeds to node 208. If the value of the feature value at location f(x, y2, c) of the feature window is not less than the threshold value of th2 (e.g., if the value of the feature value at location f(x, y2, c) of the feature window is equal to or greater than the threshold value of th2), then the decision tree proceeds to node 208.

At node 206, a feature value at a location f(x, y3, c) of the feature window is compared to a threshold th3. If the value of the feature value at location f(x, y3, c) of the feature window is less than the threshold value of th3, then the decision tree proceeds to node 212. If the value of the feature value at location f(x, y3, c) of the feature window is not less than the threshold value of th3 (e.g., if the value of the feature value at location f(x, y3, c) of the feature window is equal to or greater than the threshold value of th3), then the decision tree proceeds to node 214.

At node 208, a feature value at a location f(x, y4, c) of the feature window is compared to a threshold th4. If the value of the feature value at location f(x, y4, c) of the feature window is less than the threshold value of th4, then the constrained decision tree 200 provides value v1 216. If the value of the feature value at location f(x, y4, c) of the feature window is not less than the threshold value of th4 (e.g., if the value of the feature value at location f(x, y4, c) of the feature window is equal to or greater than the threshold value of th4), then the constrained decision tree 200 provides value v2 218.

At node 210, a feature value at a location f(x, y5, c) of the feature window is compared to a threshold th5. If the value of the feature value at location f(x, y5, c) of the feature window is less than the threshold value of th5, then the constrained decision tree 200 provides value v3 220. If the value of the feature value at location f(x, y5, c) of the feature window is not less than the threshold value of th5 (e.g., if the value of the feature value at location f(x, y5, c) of the feature window is equal to or greater than the threshold value of th5), then the constrained decision tree 200 provides value v4 222.

At node 212, a feature value at a location f(x, y6, c) of the feature window is compared to a threshold th6. If the value of the feature value at location f(x, y6, c) of the feature window is less than the threshold value of th6, then the constrained decision tree 200 provides value v5 224. If the value of the feature value at location f(x, y6, c) of the feature window is not less than the threshold value of th6 (e.g., if the value of the feature value at location f(x, y6, c) of the feature window is equal to or greater than the threshold value of th6), then the constrained decision tree 200 provides value v6 226.

At node 214, a feature value at a location f(x, y7, c) of the feature window is compared to a threshold th7. If the value of the feature value at location f(x, y7, c) of the feature window is less than the threshold value of th7, then the constrained decision tree 200 provides value v7 228. If the value of the feature value at location f(x, y7, c) of the feature window is not less than the threshold value of th7 (e.g., if the value of the feature value at location f(x, y7, c) of the feature window is equal to or greater than the threshold value of th7), then the constrained decision tree 200 provides value v8 230.

The threshold values, such as threshold th1, th2, th3, th4, th5, th6, and th7, are determined based on training the CRDF classifier. During training, multiple images of a particular object, as well as multiple images that do not include a particular object, are provided to the classifier. Because the images with the particular object are known beforehand, the threshold values are adjusted such that the CRDF classifier will produce a final value (e.g., v1, v2, v3, v4, v5, v6, or v7) based on whether a particular image includes the particular object. For example, the thresholds may be adjusted such that images with the particular object produce one final value (e.g., v1), while images without the particular object produce a different final value (e.g., v7).

The final values v1, v2, v3, v4, v5, v6, v7, and v8 can be used by the CRDF classifier to detect an object in an image. For example, the final value provided can be combined (e.g., added) with final values of other constrained decision trees to determine an object classification. The object classification can be based on the values determined during training of the CRDF classifier. The CRDF classifier may be trained for various objects. In addition, if the constraints on the constrained decision trees are changed, then the CRDF classifier may need to be re-trained. In some examples, the constrained decision trees are constrained as they were during CRDF classifier training.

For example, image capture device 102 of scanning system 100 can capture an image. Feature extractor module 106 evaluates the image by identifying areas in the image that contain features, such as objects, and provides data identifying the features to the CRDF classifier module 108. CRDF classifier module 108 can include multiple constrained decision trees 200, where each constrained decision tree 200 includes one or more constrained nodes at multiple levels 240, 250, 260. Each constrained decision tree 200 makes a determination as to the classification of the objects identified by the feature data. The determinations of each constrained decision tree are combined to provide one or more detected objects.

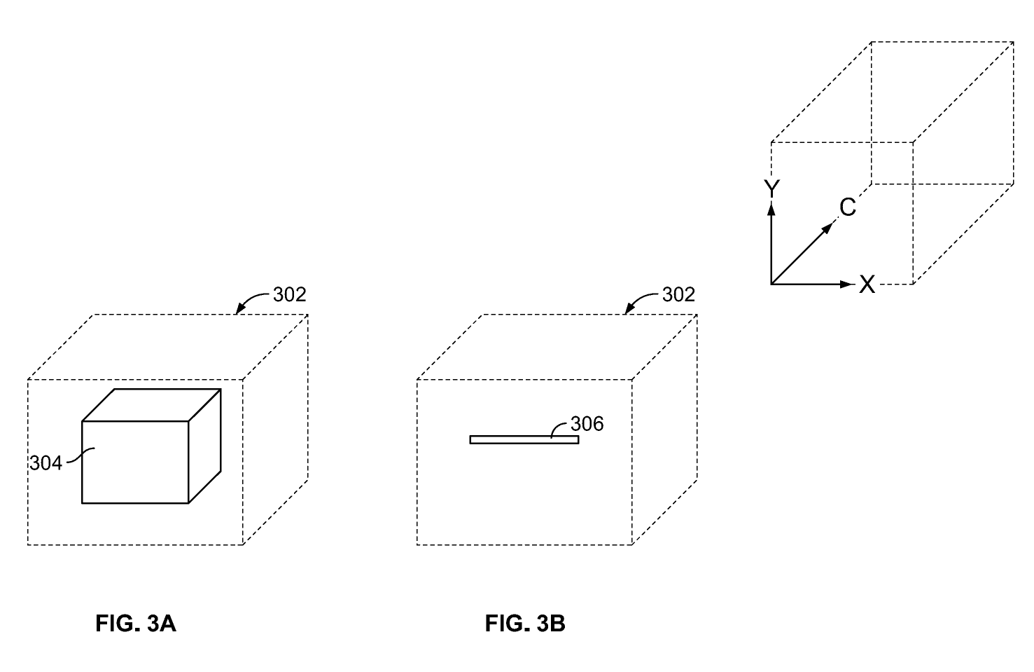

FIG. 3A illustrates an example of a feature window 304 used by a prior art decision tree of a random decision forest classifier to evaluate an area of an image represented by feature array 302. Feature array 302 can be provided by, for example, a HOG feature extractor. For example, feature window 304 can represent an area of feature array 302 that is 32 columns wide by 32 rows high by 10 channels deep. Thus a prior art decision tree may require access to up to 10,240 locations within feature window 304 (32×32×10).

FIG. 3B illustrates an example feature window 306 that can be used by a constrained decision tree, such as the constrained decision tree of FIG. 2. The feature window 306 can be used to evaluate the same area of an image that was represented by the feature array 302 evaluated in FIG. 3A using feature window 304. In this example, the constrained decision tree accesses only 1 row and 1 channel of feature array 302. For example, feature window 306 can represent an area of feature array 302 that is 32 columns wide by 1 row high by 1 channel deep. A constrained decision tree employing (e.g., including) this example feature window can access up to 32 locations within feature window 306 (32×1×1). Thus, in this example, the prior art decision tree can require 320 times more feature window locations to be accessed than the constrained decision tree to evaluate the same area of an image.

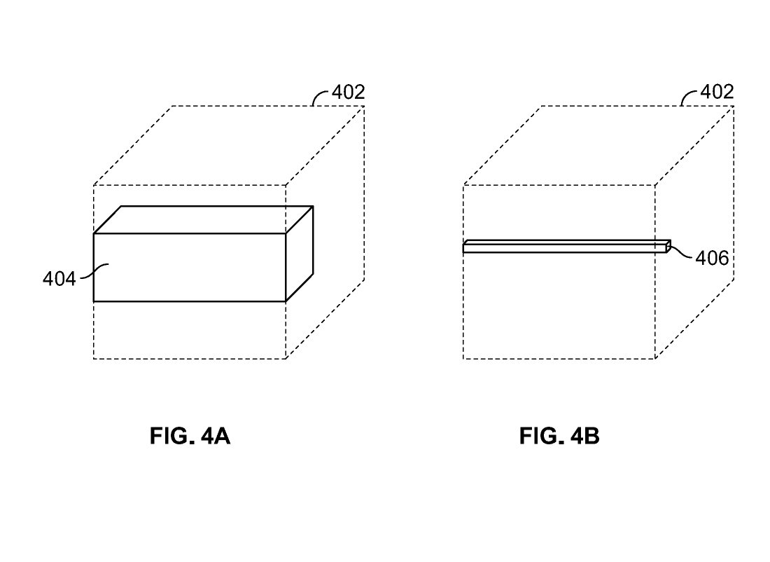

FIG. 4A illustrates an example of a feature window 404 that may be used by a prior art decision tree of a random decision forest classifier to evaluate an area of an image represented by feature array 402 that includes all columns of feature array 402. For example, feature window 404 can represent an area of feature array 402 that is 64 columns wide by 32 rows high by 10 channels deep. Thus a prior art decision tree may require access of up to 20,480 locations within feature window 404 (64×32×10).

FIG. 4B illustrates an example feature window 406 that can be used by a constrained decision tree, such as the constrained decision tree of FIG. 2. The feature window 406 can be used to evaluate the same area of an image as represented by the feature array 402 evaluated in FIG. 4A using feature window 404. In this example, the constrained decision tree accesses only 1 row and 1 channel of feature array 402, but allows access to all columns of feature array 402. For example, feature window 406 can represent an area of feature array 402 that is 64 columns wide by 1 row high by 1 channel deep. A constrained decision tree employing this example feature window 406 can access up to 64 locations within feature window 406 (64×1×1). Thus, in this example, the prior art decision tree can require 320 times more feature window locations to be accessed than the constrained decision tree to evaluate the same area of an image.

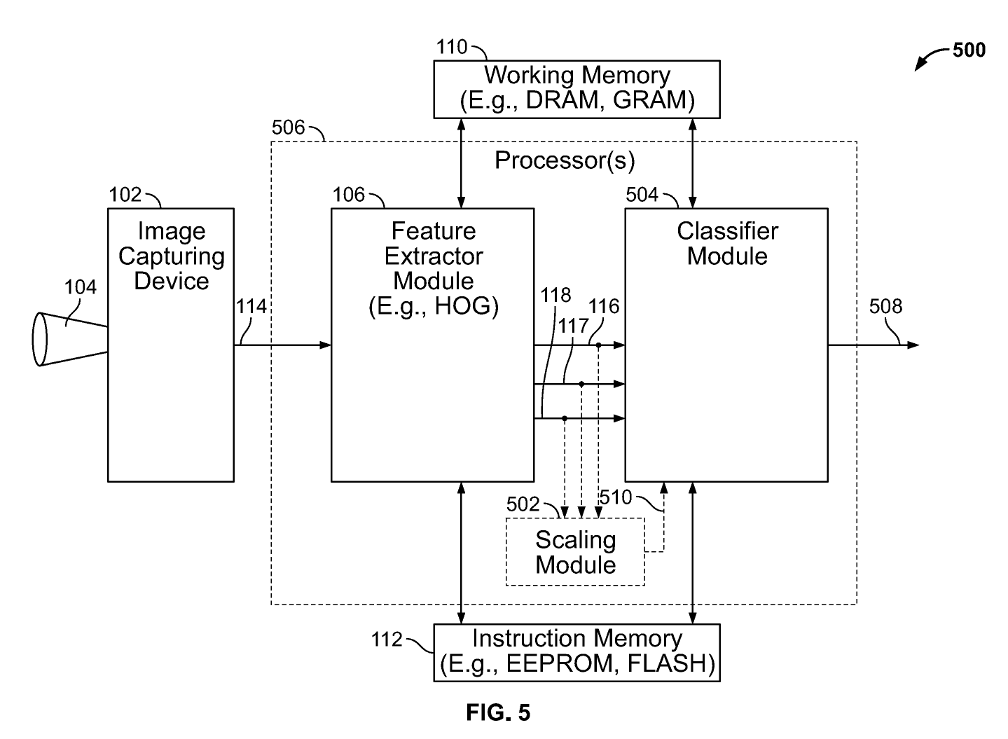

FIG. 5 is a block diagram of an exemplary scanning system 500 with a classifier module 504 that can feature data based on image color information. Classifier module 504 can be, for example, an RDF classifier, or a CRDF classifier. In this example, scanning system 500 includes an image capturing device 102 with camera(s) 104, a feature extractor module 106, an optional scaling module 502, working memory 110, and instruction memory 112. In some examples, feature extractor module 106, classifier module 504, and/or scaling module 502 (if employed) can be implemented as one or more processors 506 executing suitable executable instructions.

In this example, image capturing device 102 provides captured images via image channels 114 to feature extractor module 106. The image channels 114 can include color channels, such as red, green, and blue channels. Feature extractor module 106 can determine features based on the images received on the image channels. Feature extractor module can then provide feature data based on image color information to classifier module 504 on color based feature channel 119. Classifier module 504 can determine a feature window based on the combination of feature data received on feature channel 116 and color based feature channel 119. For example, classifier module 504 can include constrained random decision trees that evaluate feature data received on feature channel 116, and other constrained random decision trees that evaluate feature data received on color based feature channel 119.

Classifier module 504 can determine a feature window based on the feature data received on feature channels 116. For example, classifier module 504 can combine the received feature data and received image data and determine the feature window based on the combined data. Classifier module 504 can then detect one or more objects 508 in the captured image based on the feature window.

In this example each of feature extractor module 106 and classifier module 504 are in communication with instruction memory 112 and working memory 110. Instruction memory 112 can store executable instructions that can be accessed and executed by one or more of feature extractor module 106 and classifier module 504. For example, instruction memory 112 can store instructions that when executed by classifier module 504, cause classifier module 504 to perform one or more operations as described herein. In some examples, one or more of these operations can be implemented as algorithms executed by classifier module 504.

Working memory 110 can be used by feature extractor module 106 and/or classifier module 504 to store a working set of instructions loaded from instruction memory 112. Working memory 110 can also be used by feature extractor module 106 and/or classifier module 504 to store dynamic data created during their respective operations.

For example, image capture device 102 of scanning system 500 can capture an image. Feature extractor module 106 evaluates the image by identifying areas in the image that contain features, such as objects, and provides data identifying the features to the classifier module 504. Classifier module 504 also receives color data for the captured image. Classifier module 504 combines the received feature data and received color data, and determines a feature window based on the combined data.

As another example, classifier module 504 can receive feature data based on an image's pixel depth values in addition to feature data based on image luminance or color to determine a feature window. For example, image capture device 102 can include a left and a right camera, where each camera provides image data for a captured image. Image capturing device 102 can compute pixel depths for each pixel of a captured image based on the image data from the left and right cameras, and can provide the pixel depth information to feature extractor module 106. Feature extractor module 106 can provide feature data based on the pixel depth information to classifier module 504 on depth based feature channel 117. Classifier module 504 can determine a feature window based on the combination of feature data received on feature channel 116 and depth based feature channel 117. For example, classifier module 504 can include constrained random decision trees that evaluate feature data received on feature channel 116, and other constrained random decision trees that evaluate feature data received on depth based feature channel 117. In some examples, classifier module 504 can include constrained random decision trees that evaluate feature data received on color based feature channel 119, and other constrained random decision trees that evaluate feature data received on depth based feature channel 117.

In some examples, feature channel 116, depth based feature channel 117, and/or color based feature channel 119 are first scaled by scaling module 502 before being provided to classifier module 504 via feature channels 510. For example, scaling module 502 can downscale feature data received from feature channel 116, and can provide scaled feature data to classifier module 504 via feature channels 510.

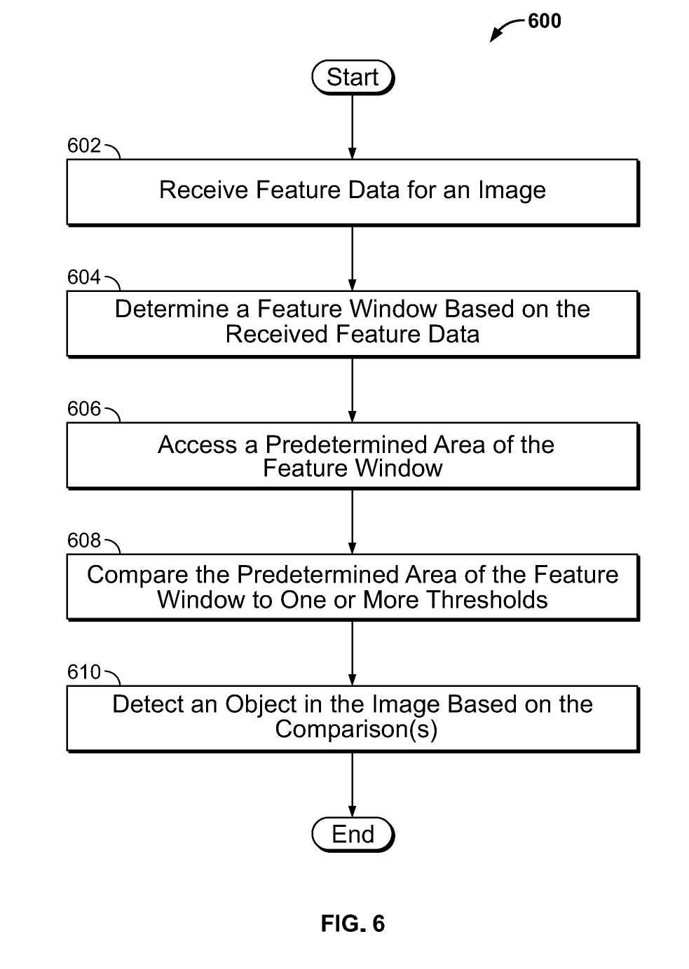

FIG. 6 is a flow chart of an exemplary method 600 by a constrained decision tree of a CRDF classifier, such as the CRDF classifier module 108 of FIG. 1. At step 602, the constrained decision tree receives feature data for an image. For example, the feature data can be feature descriptors. At step 604, the constrained decision tree determines a feature window based on the received feature data. At step 606, the constrained decision tree accesses a predetermined area of the feature window. For example, the predetermined area of the feature window can include only 1 row, 1 column, or 1 channel of the feature window. At step 608, the constrained decision tree compares the predetermined area of the feature window to one or more thresholds. For example, each node of a plurality of nodes of the constrained decision tree can compare a location of the predetermined area of the feature window to a threshold. At step 610, the constrained decision tree detects an object in the image based on the comparison(s).

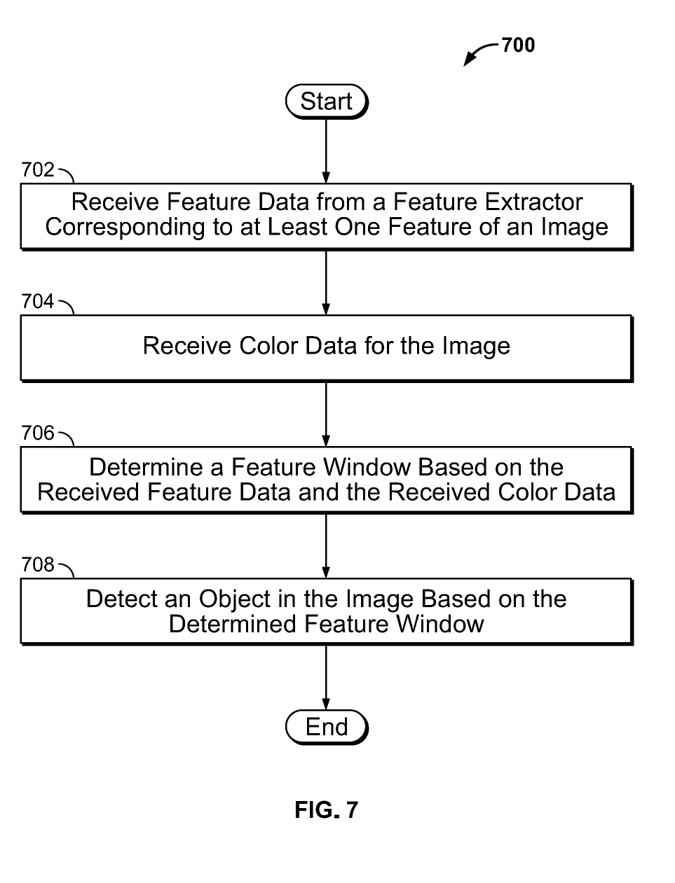

FIG. 7 is a flow chart of an exemplary method 700 by a classifier, such, as the classifier module 504 of FIG. 5. At step 702, the classifier receives feature data from a feature extractor, where the feature data corresponds to at least one feature of an image. At step 704, the classifier receives color data for the image. At step 706, the classifier determines a feature window based on the received feature data and the received color data. For example, the classifier can combine the received feature data and received color data, and determine the feature window based on the combined data. At step 708, the classifier detects an object in the image based on the determined feature window.

For example, image capture device 102 of scanning system 500 can capture an image. Feature extractor module 106 identifies areas in the image that contain features, such as objects, and provides data identifying the features to the classifier module 504. Classifier module 504 also receives color data for the captured image. Classifier module 504 combines the received feature data and received color data, and determines a feature window based on the combined data.

Although the methods described above are with reference to the illustrated flowcharts (e.g., FIG. 6, FIG. 7), it will be appreciated that many other ways of performing the acts associated with the methods can be used. For example, the order of some operations may be changed, and some of the operations described may be optional.

We claim:

1. A method for detecting an object in an image, comprising:
receiving, by a constrained random decision forest (CRDF) classifier including a plurality of constrained decision trees, at least one feature of the image;
determining, by the classifier, a feature window based on the received at least one feature of the image;
accessing, by each constrained decision tree of the plurality of constrained decision trees of the classifier, a predetermined area of the feature window;
comparing, by each constrained decision tree of the plurality of constrained decision trees of the classifier, the predetermined area of the feature window with one or more thresholds; and
detecting, by the CRDF classifier, an object in the image based on the comparisons.

2. The method of claim 1 wherein the predetermined area of the feature window comprises a single row of a plurality of rows of the feature window.

3. The method of claim 1 wherein the predetermined area of the feature window comprises a single column of a plurality of columns of the feature window.

4. The method of claim 1 wherein the feature window comprises a plurality of rows, a plurality of columns, and a plurality of channels, wherein the method comprises determining the predetermined area of the feature window to comprise at least one of: a single row of the plurality of rows, a single column of the plurality of columns, or a single channel of the plurality of channels.

5. The method of claim 4 comprising determining the predetermined area of the feature window to comprise another of the at least one of: a single row of the plurality of rows, a single column of the plurality of columns, or a single channel of the plurality of channels.

6. The method of claim 1 wherein receiving at least one feature of the image comprises receiving a feature based on at least one of color data or depth data.

7. The method of claim 1 wherein:
receiving the at least one feature of the image comprises receiving histogram of oriented gradients (HOG) values; and
determining the feature window based on the received at least one feature of the image comprises determining the feature window based on the HOG values.

8. The method of claim 1 wherein comparing, by each constrained decision tree of the plurality of constrained decision trees of the classifier, the predetermined area of the feature window with the one or more thresholds comprises comparing, by each node of a plurality of constrained nodes of each constrained decision tree, a different location of the predetermined area of the feature window with a corresponding threshold.

9. The method of claim 8 wherein the differing locations of the predetermined area of the feature window differ by one or more rows, one or more columns, or one or more channels of the feature window.

10. A constrained random decision forest (CRDF) classifier including a plurality of constrained decision trees and comprising one or more processors configured to:
receive at least one feature of the image;
determine a feature window based on the received at least one feature of the image;
access a predetermined area of the feature window;
compare, for each constrained decision tree of the plurality of constrained decision trees of the classifier, the predetermined area of the feature window with one or more thresholds; and
detect an object in the image based on the comparisons.

11. The CRDF classifier of claim 10 wherein the one or more processors are configured to determine the predetermined area of the feature window to comprises a single row of a plurality of rows of the feature window.

12. The CRDF classifier of claim 10 wherein the one or more processors are configured to determine the predetermined area of the feature window comprises a single column of a plurality of columns of the feature window.

13. The CRDF classifier of claim 10 wherein the feature window comprises a plurality of rows, a plurality of columns, and a plurality of channels, wherein the one or more processors are configured to determine the predetermined area of the feature window to comprise at least one of: a single row of the plurality of rows, a single column of the plurality of columns, or a single channel of the plurality of channels.

14. The CRDF classifier of claim 13 wherein the one or more processors are configured to determine the predetermined area of the feature window to comprise another of the at least one of: a single row of the plurality of rows, a single column of the plurality of columns, or a single channel of the plurality of channels.

15. The CRDF classifier of claim 10 wherein the one or more processors are configured to receive a feature based on at least one of color data or depth data.

16. The CRDF classifier of claim 10 wherein the one or more processors are configured to:
receive the at least one feature of the image comprises receiving histogram of oriented gradients (HOG) values; and
determine the feature window based on the received at least one feature of the image comprises determining the feature window based on the HOG values.

17. The CRDF classifier of claim 10 wherein the one or more processors are configured to compare, for each node of a plurality of constrained nodes of each constrained decision tree, a different location of the predetermined area of the feature window with a corresponding threshold.

18. The CRDF classifier of claim 17 wherein the one or more processors are configured to determine the differing locations of the predetermined area of the feature window to differ by one or more rows, one or more columns, or one or more channels of the feature window.

19. The CRDF classifier of claim 10 wherein receiving at least one feature of the image comprises receiving a feature based on at least one of color data or depth data.

20. The CRDF classifier of claim 19 wherein the one or more processors are configured to downscale the feature.

21. A non-transitory, computer-readable storage medium comprising executable instructions which, when executed by one or more processors, causes the one or more processors to:
receive at least one feature of an image;
determine a feature window based on the received at least one feature of the image;
access a predetermined area of the feature window;
compare, for each constrained decision tree of a plurality of constrained decision trees of a classifier, the predetermined area of the feature window with one or more thresholds; and
detect an object in the image based on the comparisons.

22. The non-transitory, computer-readable storage medium of claim 27 wherein the executable instructions, when executed by the one or more processors, causes the one or more processors to:
determine the predetermined area of the feature window to comprise at least one of: a single row of a plurality of rows of the feature window, a single column of a plurality of columns of the feature window, or a single channel of a plurality of channels of the feature window.
